(19) United States
(12) Patent Application Publication
(10) Pub. No.: US 2024/0022085 A1
(43) Pub. Date: Jan. 18, 2024

(54) MANAGEMENT SYSTEM AND BATTERY

(71) Applicant: HONDA MOTOR CO., LTD., Tokyo (JP)

(72) Inventor: Takashi Fujiyama, Wako-shi, Saitama-ken (JP)

(21) Appl. No.: 18/254,275

(22) PCT Filed: Nov. 30, 2020
(86) PCT No.: PCT/JP2020/044542

§ 371 Date: May 24, 2023

(51) Int. Cl. H02J 7/00; H01M 10/42

(52) U.S. Cl. CPC H02J 7/00045; H01M 10/4257; H01M 2010/4278; H01M 2010/4271

(57) ABSTRACT

This management system manages a battery mounted on a device in a detachable manner. The battery has a battery side storage unit for storing a unique device ID of the device and a control circuit. While the control circuit supplies the power of the battery when determining that a use time authentication ID obtained from the device and the device ID are consistent with each other, the control circuit stops supplying the power of the battery when determining that the use time authentication ID and the device ID are inconsistent with each other. The management system is also provided with a management unit for storing or deleting the device ID into or from the battery side storage unit when obtaining a user ID.

### TECHNICAL FIELD

The present invention relates to a management system for managing a battery that is mounted on a device in an attachable and detachable manner, and a battery.

### BACKGROUND ART

In a device such as a work machine or a vehicle that is driven with a detachable battery mounted thereon, for example, when a user temporarily moves away from the device, there is a possibility that the battery may be stolen by someone. In order to deal with such a situation, as in a verification system disclosed in JP 2019-187231 A, a technology has been proposed in which verification is performed when a battery (power supply device) is mounted on a carrier device (device), whereby unauthorized use of the battery is prevented.

Specifically, the battery disclosed in JP 2019-187231 A holds a plurality of reference carrier identifiers, acquires a unique carrier identifier from a device when verification at the time of mounting is performed, and determines whether the reference carrier identifier and the unique carrier identifier match each other. The battery allows power supply to the device when the verification has succeeded, and stops power supply to the device when the verification does not succeed.

### SUMMARY OF THE INVENTION

Incidentally, in a system in which verification is performed between a battery and a device as in JP 2019-187231 A, identification information stored in the battery cannot be changed (registered or deleted) on the user side. For example, in a sharing system in which a battery is rented to a user or shared by a plurality of users, only a business operator is configured to perform registration, deletion, and the like of identification information for authentication.

However, with such a configuration, it is not possible to immediately respond to changing situations (for example, where the device is no longer used or the battery is reused for another device). Consequently, inconvenience occurs such as a decrease in convenience for the user and an increase in burden on the business operator who sets the identification information.

The present invention has been made in view of the above circumstances, and an object thereof is to provide a management system and a battery capable of further improving convenience while preventing theft of the battery.

According to a first aspect of the present invention, there is provided a management system that manages a battery detachably mounted on a device, the battery being configured to supply power to the device, wherein the battery includes: a battery-side storage unit configured to store device identification information unique to the device; and a control unit configured to perform power supply by the battery in a case where it is determined that at-use authentication identification information held by the device matches the device identification information, in a state of the battery being attached to the device, and configured to stop power supply by the battery in a case where it is determined that the at-use authentication identification information does not match the device identification information, in the state of the battery being attached to the device, the management system including a management unit configured to store the device identification information in the battery-side storage unit or erase the device identification information from the battery-side storage unit, in a case where user identification information for identifying a user who owns the battery is acquired.

According to a second aspect of the present invention, there is provided a battery detachably mounted on a device and configured to supply power to the device, the battery including: a battery-side storage unit configured to store device identification information unique to the device; and a control unit configured to perform power supply by the battery in a case where it is determined that at-use authentication identification information held by the device matches the device identification information, in a state of the battery being attached to the device, and configured to stop power supply by the battery in a case where it is determined that the at-use authentication identification information does not match the device identification information, in the state of the battery being attached to the device, wherein the device identification information is stored in the battery-side storage unit or erased from the battery-side storage unit, by a management unit that has acquired user identification information for identifying a user who owns the battery.

The management system and the battery as above can further improve convenience while preventing theft of the battery.

### BRIEF DESCRIPTION OF DRAWINGS

FIG. 1 is an explanatory diagram showing an overall configuration of a management system according to an embodiment of the present invention;

FIG. 2 is a flowchart showing a procedure for using a sharing system;

FIG. 3 is a perspective view showing a battery rented in the sharing system;

FIG. 4 is an explanatory diagram showing a flow at the time of contract for use of a battery;

FIG. 5 is a table illustrating a usage contract database;

FIG. 6 is a block diagram for explaining operations of a battery station and a management server when user identification information is acquired;

FIG. 7 is a flowchart illustrating a process when a user rents a battery;

FIG. 8 is a block diagram for explaining an operation when a battery is mounted on a device;

FIG. 9 is a flowchart showing a process flow when a battery is mounted; and

FIG. 10 is a flowchart illustrating a process performed when a user ends using a battery.

### DETAILED DESCRIPTION OF THE INVENTION

A preferred embodiment of the present invention will be presented and described in detail below with reference to the accompanying drawings.

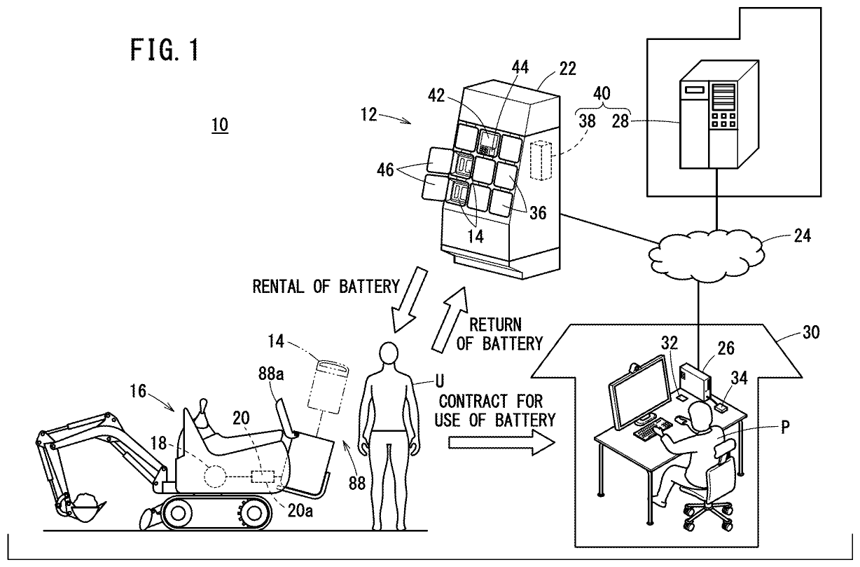

As shown in FIG. 1, a management system 10 according to an embodiment of the present invention is applied to a sharing system 12 that rents (lease or rental) a battery 14 from a business operator to a plurality of users U. A user U who rents the battery 14 in the sharing system 12 mounts the battery 14 on a device 16 and uses the device 16 based on power supply of the battery 14. The “user U” of the sharing system 12 refers to one individual and also refers to an organization (company, group, or the like) of a plurality of persons. In addition, the sharing system 12 is not limited to a form in which the business operator rents the battery 14 to the user U, and may be a form in which one or more batteries 14 are shared among a plurality of the users U.

The battery 14 rented to the user U is a general-purpose detachable battery that is detachably mounted on various devices 16. The device 16 of the user U may be owned by the user U or may be rented separately from the battery 14. Examples of the device 16 include a work machine (for example, a construction machine, a heavy machine, an industrial device, and a household device) and a mobile body (for example, a four-wheeled vehicle, a two-wheeled vehicle, an electric bicycle, a cart, and a robot). In FIG. 1, an electric excavator operated by power supply of the battery 14 is representatively illustrated as the device 16. The device 16 includes a drive source 18 such as a motor, an electrical component 20 including a control device 20a, and the like. The device 16 operates when electric power is supplied from the mounted battery 14 to the drive source 18 or the electrical component 20. The device 16 may be configured to include a battery unit (not shown) for driving the electrical component 20 with low power when the battery 14 is not mounted.

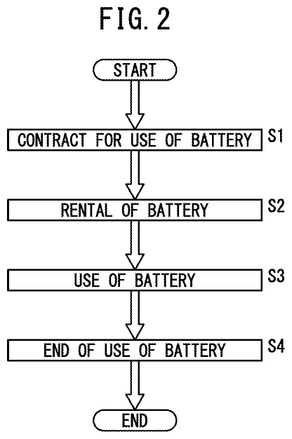

In order to facilitate understanding of the present invention, a procedure of using the sharing system 12 according to the present embodiment will be described with reference to FIG. 2.

In using the sharing system 12, the user U first makes a contract for using the battery 14 with the business operator of the sharing system 12 (step S1). During the usage period according to the usage contract, the user U goes to an appropriate battery station 22 (see FIG. 1) and rents the battery 14 from the battery station (step S2).

Then, the user U mounts the rented battery 14 on the device 16 and uses the device 16 (step S3). When the remaining battery level of the battery 14 becomes low during the usage period, the user U puts the battery 14 into the battery station 22 from which the battery 14 is received or into a battery station 22 different from the battery station 22 from which the battery 14 is received. Thus, the battery station 22 charges the accommodated battery 14. When the user wishes to continuously use the battery 14, the user U newly rents the charged battery 14 from the battery station 22.

When terminating the use of the battery 14, the user U returns the battery 14 to the battery station 22 and further performs a usage termination procedure to terminate the usage contract (step S4).

In order to implement the above-described usage procedure, the sharing system 12 is constructed as a client-server type using a network 24 such as the Internet or an intranet at the business operator of the system, as shown in FIG. 1. The sharing system 12 is configured to be connected to the network 24, and includes a business operator terminal 26, a management server 28, and the above-described battery station 22. Alternatively, the battery 14 itself may have a wireless communication function capable of being connected to the network 24, and may communicate with the management server 28 during use by the user U or during standby at the battery station 22.

The business operator of the sharing system 12 includes a business operator facility 30 that the user U visits when making a contract to use the battery 14. In the business operator facility 30, a business operator terminal 26 operated by a person in charge P on the business operator side is installed. For example, a computer (a desktop computer or a laptop computer) capable of communicating via the network 24 is applied as the business operator terminal 26. An information processing terminal such as a PDA, a tablet, a smartphone, a mobile phone, or a wearable computer may be applied as the business operator terminal 26. In addition, the business operator may carry the business operator terminal 26 to perform business, and does not necessarily need to include the business operator facility 30.

The business operator gives user identification information (hereinafter, referred to as a user ID) to the user U who has made the usage contract. The user ID refers to information for individually identifying the user U who owns the battery 14 (the term “own” includes the concept of “rental” or “possession” in the embodiment). The user ID is set by designation by the user U or automatic assignment by the business operator side, and is transmitted to the management server 28 via the business operator terminal 26, whereby the use ID is managed by the business operator terminal 26 and the management server 28. The business operator facility 30 includes an IC card 32 having a RF tag built-in and a writer 34 connected to the business operator terminal 26 for writing information in the IC card 32. The business operator issues the IC card 32 storing information including the user ID to the user U who has made a usage contract.

The battery station 22 is formed in a shelf shape in which slots 36 capable of accommodating a plurality of batteries 14 are arranged in a matrix, and is installed, for example, outside the business operator facility 30. The battery station 22 has a function as a charger that charges the battery 14 when the battery 14 is put into the battery station by the user U or the person in charge P on the business operator side, and a function as an exchanger that exchanges the battery 14 with another battery 14. It is more preferable that the battery stations 22 be installed at various places in town. For example, the battery station 22 may be temporarily installed at a place (work site) where a user or the like works using the device 16.

The battery station 22 includes a computer (rental control unit 38) including one or more processors, a memory, and an input/output interface (not shown), and is configured to be able to communicate with the management server 28. In the sharing system 12, the rental control unit 38 and the management server 28 configured to be capable of exchanging information with each other correspond to a management unit 40 that manages the user ID and device identification information to be described later.

There are provided, outside the battery station 22, a touch panel 42 or another operation unit that displays an image under the control of the rental control unit 38 and recognizes and receives an image operation performed by the user U, and a reader 44 (input unit) that reads information from the IC card 32 of the user U. Furthermore, each of the slots 36 of the battery station 22 includes a communication module (not shown) that perform information communication with the accommodated battery 14, and a battery lock mechanism 46 that switches between a removal permission state and a removal prohibition state of the battery 14.

The rental control unit 38 of the battery station 22 acquires information such as battery identification information (hereinafter referred to as battery ID) and the remaining battery level of the battery 14 from the accommodated battery 14 via the communication module, and automatically transmits the acquired information to the management server 28. In addition, the rental control unit 38 processes the operation of the touch panel 42 performed by the user U and the information of the IC card 32 acquired by the reader 44, and performs information communication with the management server 28 to appropriately manage the battery 14 to be rented to the user U.

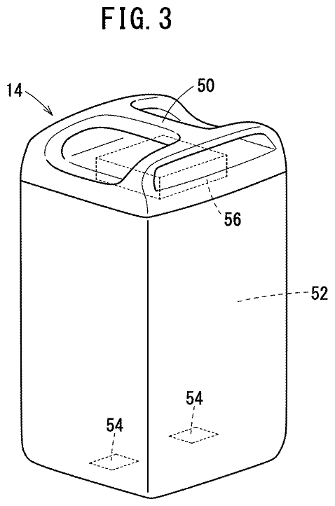

As shown in FIG. 3, for example, the battery 14 rented to the user U is formed in a prismatic shape as a whole, and includes a handle 50 to be held by the user U, at one end portion. The battery 14 includes a battery cell main body 52 that actually stores and discharges electric power, a plurality of terminals 54 through which electric power can be input and output, and a control circuit 56 that controls charging and discharging of the battery 14.

The battery cell main body 52 is configured to have an appropriate output voltage, battery capacity, and the like by connecting a plurality of battery cells (not shown) such as liquid batteries and all-solid-state batteries. The plurality of terminals 54 are provided on a side of the battery opposite (or identical) to a side thereof where the handle 50 is provided, for example. The terminals 54 come into contact with device-side terminals (not shown) when the battery 14 is mounted on the device 16, and come into contact with battery-station-side terminals (not shown) when the battery 14 is housed in the battery station 22.

The control circuit 56 is configured as a computer including one or more processors, memories, and input/output interfaces (not shown). The control circuit 56 performs authentication when the battery 14 is mounted on the device 16, and controls discharging of the battery cell main body 52. This configuration will be described in detail later.

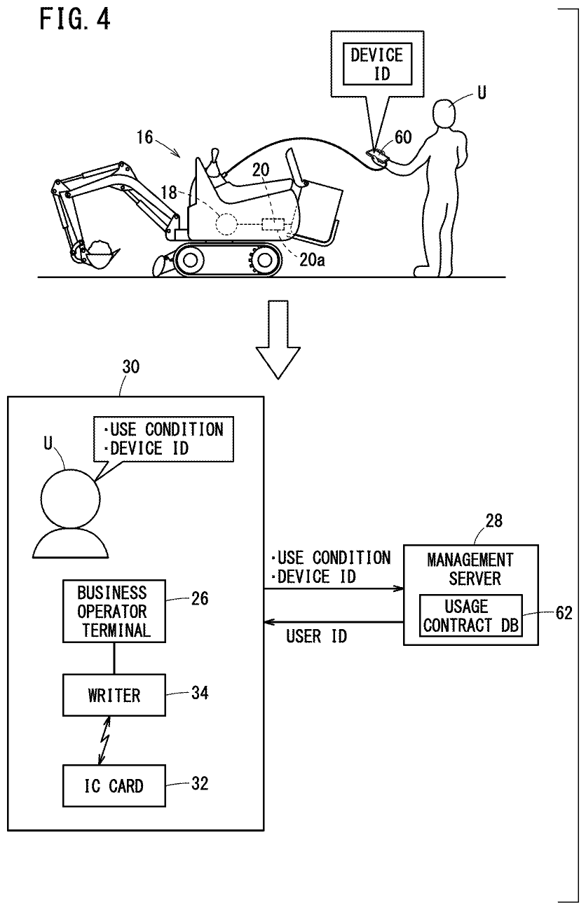

Hereinafter, the configuration of the sharing system 12 according to the present embodiment will be described in more detail in accordance with the usage procedure of FIG. 2. The user U who desires to use the sharing system 12 goes to the business operator facility 30 and makes a contract for using the battery 14 with the business operator (step S1). Before going to make the usage contract, as shown in FIG. 4, the user U prepares device identification information (hereinafter referred to as a device ID) in advance, as information of the device 16 in which the battery 14 is to be mounted.

The device IDs are identifiers normally assigned to the respective devices 16, and which are unique to the devices 16. The device IDs are set to different codes even if the devices 16 belong to the same model. For example, the device ID is set by a manufacturer at the time of manufacturing the device 16, and is attached to an instruction manual, a warranty certificate, or the like, as information for identifying the device 16. The control device 20a of the device 16 stores the device ID in advance. The sharing system 12 may be configured such that a user terminal 60 (a portable information processing device such as a smartphone, a laptop computer, a PDA, or a tablet) carried by the user U and the device 16 can perform information communication with each other. In this case, as shown in FIG. 4, an application (not shown) of the user terminal 60 may be configured to automatically acquire the device ID from the device 16 by communicating with the device 16.

In the usage contract of the battery 14, the user U who has visited the business operator facility 30 gives the use condition and the device ID of the battery 14 to a person in charge P of the business operator facility 30 to make the usage contract. Examples of the use condition include personal information (for example, a name, an address, a telephone number, and a mail address) of the user U, a date and time for starting the use (usage start date and time), a date and time for ending the use (usage end date and time), the number of batteries to be used, a place of use, and the like. The person in charge P inputs the use condition and the device ID to the business operator terminal 26, accesses the management server 28 via the business operator terminal 26, and sets the user ID unique to the user U. When the user ID is already set by having already used the sharing system 12, the person in charge P reads the user ID and inputs the use condition in association with the user ID.

The user ID, the use condition, and the device ID input to the business operator terminal 26 are transmitted to the management server 28 and managed by the business operator terminal 26 and the management server 28. When the user U uses a plurality of devices 16 in the use of the battery 14, the user U prepares the device ID for each of the devices 16. The business operator terminal 26 and the management server 28 manage the plurality of inputted device IDs in association with the user ID.

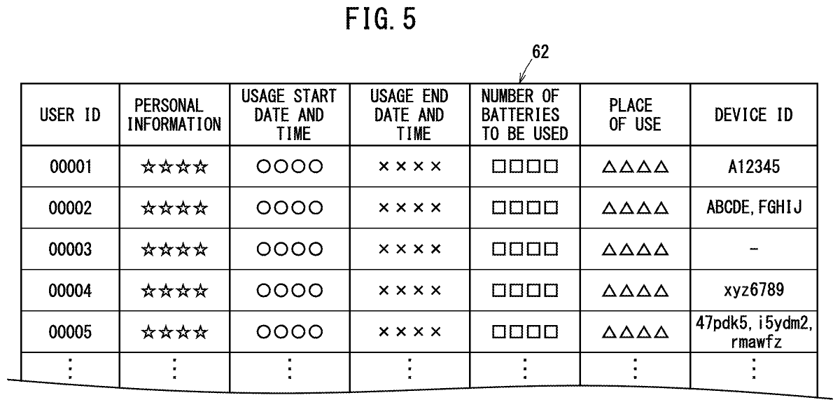

The management server 28 holds a usage contract database 62 (hereinafter referred to as a usage contract DB 62) in advance. The management server 28 registers the user ID, the use condition, and one or more device IDs in the usage contract DB 62 when the user ID, the use condition, and the one or more device IDs are transmitted from the business operator terminal 26. As illustrated in FIG. 5, the usage contract DB 62 stores the user ID, the personal information, the usage start date and time, the usage end date and time, the number of batteries to be used, the place of use, and one or more device IDs, in association with one another. The management server 28 monitors the rented state of the battery 14 to the contracted user U at a predetermined point in time, by referring to the usage contract DB 62 while measuring the date and time.

Referring back to FIG. 4, the business operator issues the IC card 32 by writing the user ID and the one or more device IDs stored in the business operator terminal 26 into the IC card 32 via the writer 34. The sharing system 12 is not limited to storing the user ID and the device IDs in the IC card 32, but may be configured to store the user ID and the device IDs in the user terminal 60 or the like. The user terminal 60 includes a communication module capable of communicating with the reader 44 of the battery station 22. When the user terminal 60 is brought close to the reader 44 by the user U, the user terminal 60 transmits the user ID and the like to the rental control unit 38. Alternatively, the sharing system 12 may be configured to write only the user ID in the IC card 32.

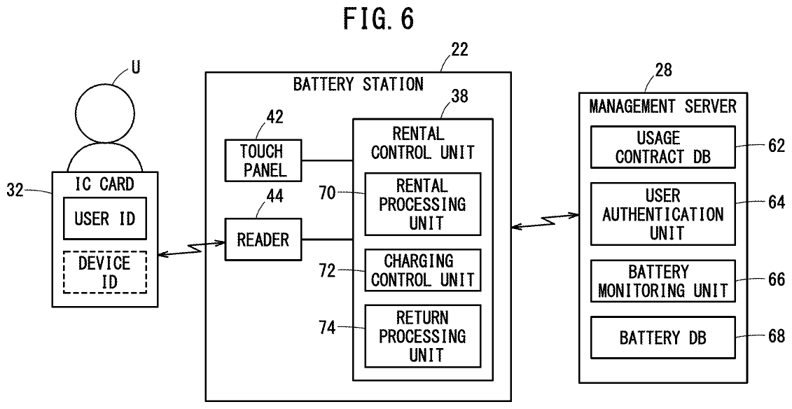

After the usage contract has been made, the user U rents the battery 14 from the battery station 22 during the usage period (step S2 in FIG. 2). At this time, as shown in FIG. 6, the rental control unit 38 of the battery station 22 and the management server 28 rent the battery 14 to the user U by performing information communication with each other while performing appropriate processing. The rental control unit 38 includes a rental processing unit 70, a charging control unit 72, and a return processing unit 74. The management server 28 contains a user authentication unit 64, a battery monitoring unit 66, and a battery database 68 (hereinafter referred to as a battery DB 68).

The battery DB 68 stores information on a plurality of batteries 14 provided by the business operator. For example, the battery DB 68 stores therein a battery ID of each battery, a battery station 22 (or a current position) to which the battery belongs, the remaining battery level of each battery, a rental state of each battery, such as out on loan/not rented, the usage period (usage start date and time, usage end date and time) concerning each battery rented to the user U, the user ID of each user U to which the battery is rented, and the like. The usage contract DB 62 and the battery DB 68 cooperate with each other so as to being capable of mutual federation. Thus, regarding information common to both the DB, when information in one DB is rewritten, the corresponding information in the other DB is also rewritten.

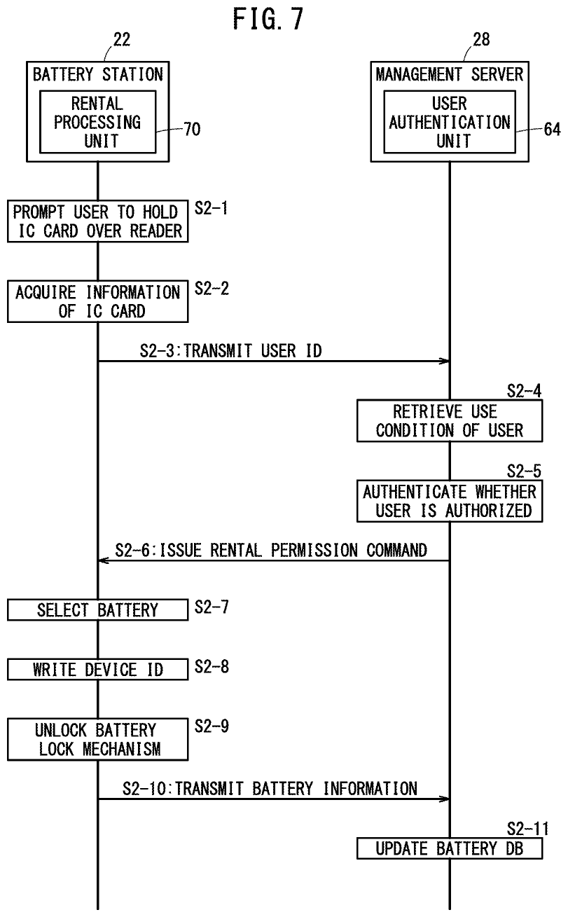

The rental processing unit 70 of the rental control unit 38 performs processing for renting the battery 14 to the user U in accordance with the processing flow of FIG. 7, for example. Specifically, the user U carries the IC card 32 and goes to the battery station 22. The user U performs a rental operation of the battery 14 via the touch panel 42 of the battery station 22. When recognizing and receiving the rental operation, the rental processing unit 70 prompts the user to hold the IC card 32 over the reader 44 (step S2-1). When the user U brings the IC card 32 close to the reader 44, the reader 44 reads the information (user ID, device ID) of the IC card 32 and transmits the read information to the rental control unit 38.

Then, the rental processing unit 70 acquires the information of the IC card 32 from the reader 44 and stores it (step S2-2). Further, the rental processing unit 70 transmits the user ID to the management server 28 together with rental request information indicating a rental request from the user U (step S2-3).

When the user authentication unit 64 of the management server 28 receives the rental request information and the user ID from the battery station 22, the user authentication unit 64 reads the usage contract DB 62 and retrieves the use condition of the user U registered in the usage contract DB 62, based on the user ID (step S2-4). Further, the user authentication unit 64 determines whether or not the current date and time matches the usage start date and time and the usage end date and time of the retrieved use condition, and compares the number of batteries 14 currently rented to the user U with the number of batteries to be used, specified in the use condition, with reference to the battery DB 68. That is, in the sharing system 12 according to the present embodiment, at this timing, the management server 28 authenticates whether or not the user U is an authorized user who is authorized to rent the battery 14 (step S2-5).

Then, in the user authentication, when the user authentication unit 64 determines that the user U is authorized to rent the battery 14, the user authentication unit 64 transmits a rental permission command to the battery station 22 (step S2-6). The rental permission command includes the number of batteries to be used and the device ID(s) in addition to the information indicating rental of the battery 14 is permitted. The user authentication unit 64 transmits a rental non-permission command to the battery station 22 when the user U is not under the usage contract, when the timing of the rental request does not coincide with the usage period, when the number of batteries specified in the contract has already been rented, or the like. When the rental processing unit 70 receives the rental non-permission command, the rental processing unit 70 displays a message to the effect that rental of the battery 14 is not permitted and information concerning its reason, on the touch panel 42.

On the other hand, when the rental processing unit 70 receives and stores the rental permission command, the rental processing unit 70 checks the remaining battery levels of the accommodated batteries 14 and selects batteries 14 having a sufficient remaining battery level, in accordance with the number of batteries to be used (step S2-7). At this time, when a plurality of batteries 14 are not rented, the rental control unit 38 selects the plurality of batteries 14. Further, for example, when the number of batteries to be used specified in the usage contract is two and one battery 14 is already rented to the user U, the rental control unit 38 selects one battery 14, based on the rental permission information.

Further, the rental processing unit 70 writes the device ID associated with the user ID, to the control circuit 56 of the selected battery 14 (step S2-8). The control circuit 56 of the battery 14 contains therein a battery-side storage unit 80 capable of storing and erasing one or more device IDs. The battery is rented to a user U in a state where the device IDs are stored in the battery-side storage unit 80. When a plurality of batteries 14 are rented to the user U, the rental processing unit 70 assigns a device ID to each battery 14. When a plurality of device IDs are associated with the user ID, the rental processing unit 70 assigns a plurality of device IDs to each battery 14.

Then, the rental processing unit 70 unlocks the battery lock mechanism 46 that puts the selected battery 14 into an unremovable state (step S2-9), and notifies the user U of the position of the unlocked battery 14. Thus, the user U rents the battery 14 by taking out the unlocked battery 14.

In addition, the rental processing unit 70 transmits information (the battery ID, the remaining battery level, and the like) of the battery 14 rented to the user U, to the management server 28 (step S2-10). When the management server 28 receives the information of the battery 14, the management server 28 reads the battery DB 68, associates the battery ID with the user ID, performs a process of changing the rental status of the battery 14 to “out on loan”, and thus updates the battery DB 68 (step S2-11).

Note that the processing flow at the time of renting the battery 14 is not limited to the above. For example, in a case that the user U always goes to the same battery station 22 to rent the battery 14, the management server 28 may transmit in advance the use condition (the user ID and the number of batteries to be used) of the user U, to the rental control unit 38, according to the date and time, and the user authentication may be performed in the rental control unit 38. For example, the sharing system 12 may not be configured to assign, to the battery 14, the device ID transmitted from the management server 28 to the rental control unit 38, but may be configured to assign, to the battery 14, the device ID acquired from the IC card 32.

Next, a process when the user U uses the rented battery 14 (step S3 in FIG. 2) will be described. At this time, the sharing system 12 performs device authentication between the battery 14 and the device 16 to authenticate whether or not the device 16 is a device 16 registered in advance by the user U for use. By the device authentication, the sharing system 12 supplies the charged power of the battery 14 to the device 16 registered by the user U, and prohibits the power supply to the device 16 not registered.

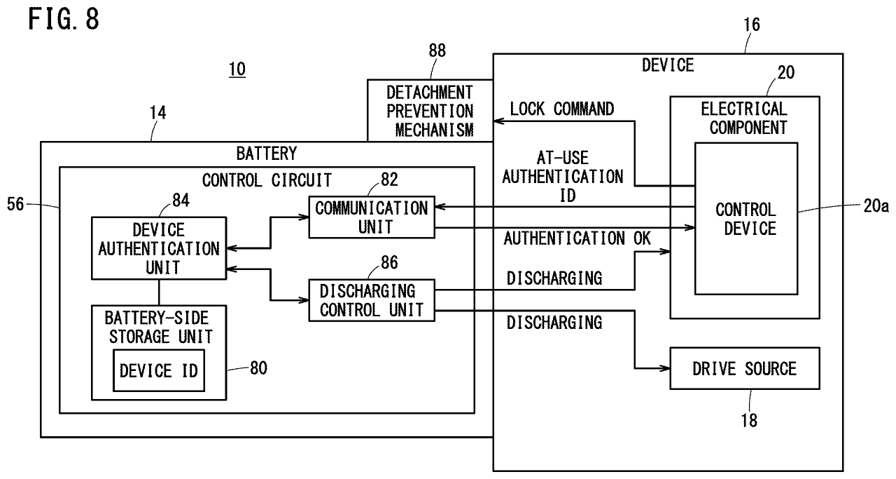

Specifically, as shown in FIG. 8, the control circuit 56 of the battery 14 stores the device ID transmitted from the battery station 22 in the battery-side storage unit 80, when the user U rents the battery 14. In the control circuit 56, various functional units are formed by the processor executing a program (not shown) stored in a memory. Specifically, the control circuit 56 includes a communication unit 82 that performs information communication with the device 16, a device authentication unit 84 that performs device authentication, and a discharging control unit 86 that controls discharging from the battery 14 to the device 16.

When the battery 14 is attached to the holder of the device 16, the communication unit 82 of the control circuit 56 communicates with the control device 20a of the device 16 to acquire at-use authentication identification information (hereinafter referred to as at-use authentication ID) stored in the control device 20a. The at-use authentication ID is the device ID itself (information on the device ID) that the device 16 has in advance. When the at-use authentication ID is acquired, the device authentication unit 84 checks the device ID against the at-use authentication ID, and determines whether the device ID and the at-use authentication ID match each other or not. When the IDs match each other, the device 16 is authenticated as a device to which power of the battery 14 is authorized to be supplied (hereinafter, the device 16 for which the IDs match each other is referred to as an authorized device). It is preferable that the device authentication unit 84 continues to confirm the continuous use of the battery 14 with respect to the device 16 by periodically performing the device authentication even after the device authentication unit 84 has confirmed the authorized device.

The discharging control unit 86 places the battery 14 in a discharging prohibition state in which power supply from the battery 14 to the device 16 is prohibited, until the device authentication unit 84 authenticates that the device 16 is an authorized device. Therefore, stoppage of driving of the device 16 is continued. Also when the device authentication unit 84 authenticates mismatch between the device ID and the at-use authentication ID, the discharging control unit 86 maintains the discharging prohibition state. As a result, the sharing system 12 can prevent the battery 14 from being used in a device 16 that is different from the authorized devices, and can prevent theft of the battery 14.

Upon authenticating that the device ID and the at-use authentication ID match each other (i.e., that the device is an authorized device), the discharging control unit 86 shifts from the discharging prohibition state to the discharging permission state in which the power supply of the battery 14 is permitted. As a result, electric power is supplied from the battery 14 to the drive source 18 or the electrical component 20, whereby the device 16 performs an appropriate operation under the operation of the user U.

The device 16 preferably includes a detachment prevention mechanism 88 (see FIG. 1) that prevents detachment of the battery 14. The detachment prevention mechanism 88 includes, for example, a lid 88a that closes a case that accommodates the battery 14 and a lock portion (not shown) that locks the lid 88a. When the control device 20a receives the information of the authorized device from the control circuit 56 of the battery 14, the control device 20a causes the detachment prevention mechanism 88 to lock the lid 88a. Thus, the device 16 can prevent theft of the battery 14 in a case where the user U temporarily leaves the device 16 during use by the user U, for example.

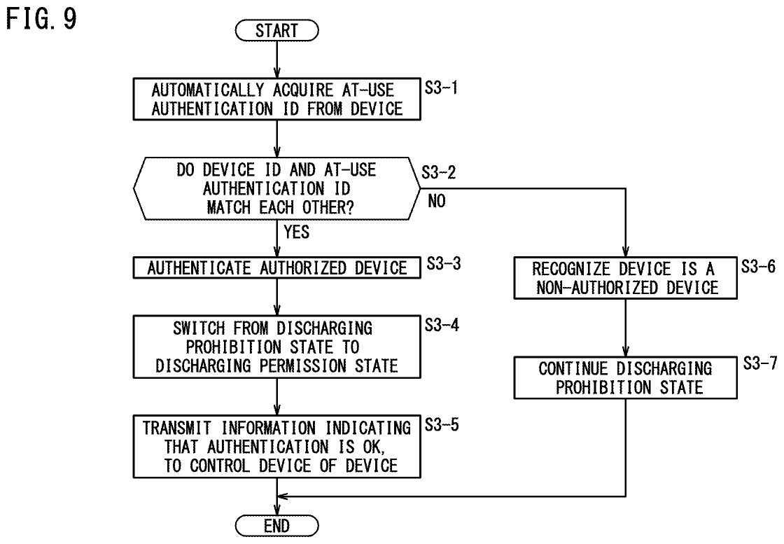

Hereinafter, a processing flow when the battery 14 is mounted will be described with reference to FIG. 9. When the user U attaches the rented battery 14 to the holder of the target device 16, the control circuit 56 (communication unit 82) of the battery 14 automatically acquires the at-use authentication ID from the device 16 (step S3-1).

Then, the device authentication unit 84 of the control circuit 56 performs device authentication to determine whether or not the device ID stored in advance and the acquired at-use authentication ID match each other (step S3-2).

In the device authentication, when the device ID and the at-use authentication ID match each other (step S3-2: YES), the device authentication unit 84 authenticates that the device 16 in which the battery 14 is mounted is an authorized device (step S3-3). As a result, the discharging control unit 86 of the control circuit 56 switches from the discharging prohibition state to the discharging permission state, thereby enabling the power supply from the battery 14 to the device 16 (step S3-4). Further, the control circuit 56 transmits information indicating that the device 16 is an authorized device (i.e., the authentication is OK) to the control device 20a of the device 16 (step S3-5). As a result, the control device 20a outputs a lock command to the detachment prevention mechanism 88, for example, so that the detachment prevention mechanism 88 can lock the battery 14.

On the other hand, in the device authentication, when the device ID and the at-use authentication ID do not match (step S3-2: NO), the device authentication unit 84 recognizes that the device 16 in which the battery 14 is mounted is not an authorized device (i.e., it is a non-authorized device) (step S3-6). Accordingly, the discharging control unit 86 of the control circuit 56 continues the discharging prohibition state in which the discharging of the battery 14 is prohibited (step S3-7).

As described above, the battery 14 can supply charged power only to the device 16 registered by the user U, by performing device authentication using the device ID when the battery 14 is attached to the device 16.

Returning back to FIG. 6, when the remaining battery level of the battery 14 becomes low during the usage period of the battery 14, the user U charges or exchanges the battery 14 by putting the battery 14 into the battery station 22 or into another charger. The charging control unit 72 of the battery station 22 communicates with the control circuit 56 when the battery 14 is put into the battery station, and the charging control unit 72 acquires the battery ID and the remaining battery level, and manages the charging state. At this time, the charging control unit 72 can charge the battery 14 in a state of storing the device ID, and thus the user U can easily take out the same battery 14. The management unit 40 may be configured to acquire the user ID from the IC card 32 and perform user authentication when the battery 14 is put into the battery station for charging. As a result, the battery 14 can be charged only when the authorized user U puts the battery 14 into the battery station, and thus theft of the battery 14 can be further prevented.

Alternatively, when the user U wants to replace the current battery 14 with another battery 14 that has been charged, the user U performs an operation of requesting a battery replacement, via the touch panel 42. At this time, the charging control unit 72 prompts the user U to hold the IC card 32 over the reader 44. When the user ID of the IC card 32 is read, the charging control unit 72 erases the device ID of the current battery 14 accommodated in the slot 36 (see also the process at the time of returning the battery 14 described later) and selects another battery 14 that has been charged. Further, the charging control unit 72 assigns the device ID to the selected battery 14, so that this battery 14 can be rented to the user U. When the battery 14 is replaced, the rental control unit 38 transmits the battery ID of the replaced battery 14 to the management server 28, and the management server 28 updates the association between the battery ID of the battery DB 68 and the user ID and the device ID, based on the transmitted information.

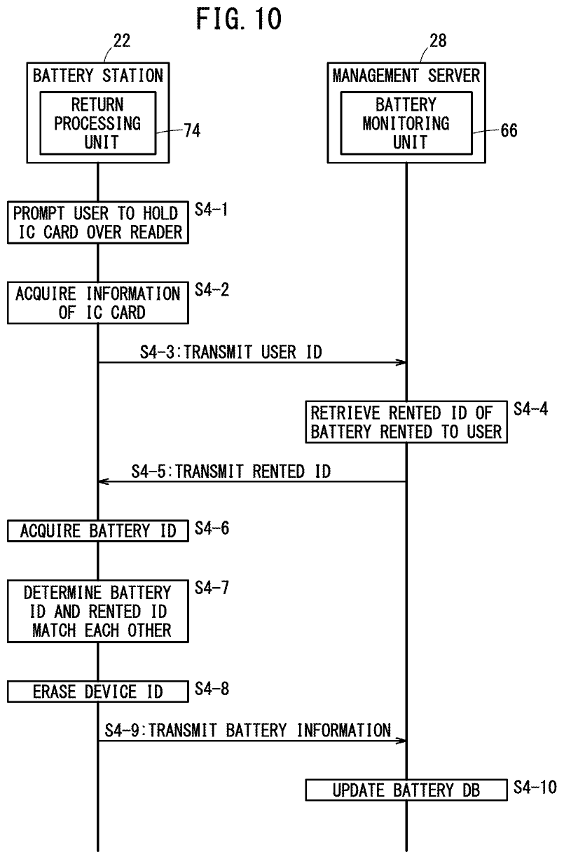

Next, a process when the user U ends using the rented battery 14 (step S4 in FIG. 2) will be described. As shown in FIG. 10, the rental control unit 38 of the battery station 22 and the management server 28 perform processing for ending the use of the battery 14 by performing information communication with each other while performing appropriate processing. At this time, the return processing unit 74 (see FIG. 6) of the rental control unit 38 erases the device ID stored in the accommodated battery 14, based on the return operation of the battery 14 by the user U and the acquisition of the user ID from the IC card 32.

Specifically, when the return processing unit 74 recognizes the return operation by the user U via the touch panel 42, the return processing unit 74 prompts the user U to put the battery 14 scheduled to be returned, into the slot 36, and to hold the IC card 32 over the reader 44 (step S4-1). When the user U brings the IC card 32 close to the reader 44, the reader 44 reads the information (user ID) of the IC card 32 and transmits the information to the rental control unit 38. Thus, the return processing unit 74 acquires and stores the information of the IC card 32 (step S4-2).

Further, the return processing unit 74 transmits the acquired user ID to the management server 28 (step S4-3). The battery monitoring unit 66 of the management server 28 retrieves, from the battery DB 68, a battery ID (hereinafter referred to as a rented ID) of a battery rented to the user U, based on the user ID (step S4-4), and transmits the rented ID to the battery station 22 (step S4-5).

On the other hand, the return processing unit 74 acquires and stores the battery ID from the battery 14 accommodated in the slot 36 (step S4-6). Then, the return processing unit 74 checks the acquired battery ID against the received rented ID, and determines whether or not the IDs match each other (step S4-7).

When the battery ID and the rented ID match each other, the return processing unit 74 erases the device ID stored in the battery 14 (step S4-8). That is, the battery station 22 erases the device ID of the battery 14, based on the acquisition of the user ID from the IC card 32. As a result, the battery 14 becomes a blank state of having no device ID, and the return of the battery 14 by the user U is completed.

At this time, even when the battery 14 stores a plurality of device IDs, the return processing unit 74 collectively erases the plurality of device IDs upon acquiring the user ID. When the user U puts a plurality of batteries 14 in the respective slots 36, the return processing unit 74 collectively erases the device IDs of the batteries 14.

Further, the return processing unit 74 transmits information (the battery ID, the remaining battery level, and the like) of the battery 14 which has been returned by the user U, to the management server 28 (step S4-9). Upon receiving the information of the battery 14, the management server 28 reads the battery DB 68, erases the user ID and the device ID associated with the battery ID, and updates the rental status of the battery 14 to “not rented” (step S4-10).

As described above, in the sharing system 12, the battery 14 performs device authentication based on the device ID and switches between permission and prohibition of discharging, thereby preventing theft of the battery 14. Moreover, the device ID in the battery 14 can be easily stored or erased by acquiring the user ID by the battery station 22 (charger or exchanger).

In addition, the sharing system 12 manages the number of batteries 14 to be rented to the user U (the number of batteries 14 to be used) for each user ID, and assigns device IDs to the number of batteries 14 associated with the user ID. Therefore, the sharing system 12 can avoid a situation where a large number of batteries 14 is rented to only one user U, and thus can prevent other users U from being unable to rent batteries from the battery station.

The present invention is not limited to the above-described embodiments, and various modifications can be made within the scope of the invention. The sharing system 12 (management system 10) may be configured such that the user U accesses the management server 28 through the user terminal 60 possessed by the user U and make a usage contract for use of the battery 14 (including application for the device IDs). At this time, the management server 28 transmits the user ID to the user terminal 60, so that the user terminal 60 can manage the user ID. When the user U goes to the battery station 22 and rents the battery 14 therefrom, the user U inputs the user ID to the battery station 22, whereby the battery station 22 causes the battery 14 to store the device ID and rents the battery 14 to the user U.

In another modification, the management system 10 can also be configured by the battery 14 owned or rented by the user U, a charger (not shown), and the device 16. In this case, the charger has the function of the above-described management unit 40 including a computer having one or more processors, a memory, and an input/output interface. The charger is configured to be able to write the device ID onto the battery-side storage unit 80 of the battery 14 and to be able to erase the device ID from the battery-side storage unit 80, based on the acquisition of the user ID.

By performing device authentication using the device ID also for the battery 14 owned or rented by the user U in this way, theft of the battery 14 can be prevented. In addition, since the charger stores and erases the device ID based on the user ID, the user U can easily switch the devices 16 to which the battery 14 is applied.

Alternatively, in the management system 10, the function of the above-described management unit 40 may be provided in the control circuit 56 itself of the battery 14 owned or rented by the user U. For example, the battery 14 includes an acquisition unit (not illustrated) such as a reader capable of acquiring the user ID, and stores the user ID and the device ID in the control circuit 56 in advance. When the user ID is acquired via the acquisition unit, the control circuit 56 checks the acquired user ID against the stored user ID, and erases the stored device ID if the IDs match each other.

In this case, the discharging control unit 86 performs the above-described device authentication in a case of holding the device ID, thereby performing power supply if the IDs match and prohibiting power supply if the IDs do not match. On the other hand, in a case of not holding the device ID, the discharging control unit 86 may be configured to supply power to the attached device 16 without performing device authentication. Accordingly, when the user U suddenly uses a device 16 different from a device 16 the user U plans to use, the user U can apply the battery 14 to the different device 16 by erasing the device ID.

The device authentication unit 84 and the discharging control unit 86 may be provided not only in the control circuit 56 of the battery 14 but also in the control device 20a of the device 16. The user ID is not limited to the configuration in which the IC card 32 or the user terminal 60 of the user U is read by the reader 44 of the battery station 22, and may be input by the user U operating the touch panel 42 or another operation unit. The battery station 22 is not limited to having both the function as a charger for charging the battery 14 and the function as an exchanger for exchanging the battery 14, but may be configured to have either the function as a charger or the function as an exchanger.

A description will be given below concerning the technical concepts and advantageous effects capable of being grasped from the above-described embodiments.

A first aspect of the present invention is the management system 10 that manages the battery 14 detachably mounted on the device 16, the battery being configured to supply power to the device 16, wherein the battery 14 includes: the battery-side storage unit 80 configured to store the device identification information (device ID) unique to the device 16; and the control unit (the control circuit 56) configured to perform power supply by the battery 14 in a case where it is determined that at-use authentication identification information (at-use authentication ID) held by the device 16 matches the device identification information, in a state of the battery being attached to the device 16, and configured to stop power supply by the battery 14 in a case where it is determined that the at-use authentication identification information does not match the device identification information, in the state of the battery being attached to the device 16, the management system including the management unit 40 configured to cause the device identification information to be stored in the battery-side storage unit 80 or cause the device identification information to be erased from the battery-side storage unit 80, in a case where user identification information (user ID) for identifying a user U who owns the battery 14 is acquired.

According to the above, the management system 10 supplies power to the battery 14 when the control unit (control circuit 56) of the battery 14 determines that the device identification information (device ID) and the at-use authentication identification information (at-use authentication ID) match each other. Therefore, in the management system 10, the user can easily use the target device 16 upon mounting the battery 14 on the device 16. Moreover, the management unit 40 causes the device identification information to be stored in or erased from the battery-side storage unit 80, based on the acquisition of the user identification information (user ID), and thus it is possible to easily update the device identification information of the battery 14. Therefore, the management system 10 further enhances convenience of capable of using the battery 14 to various devices 16. Since the user identification information is required to store or erase the device identification information, a person other than the user U of the battery 14 cannot use the power of the battery 14. As a result, theft of the battery 14 is prevented. Further, in such a system, the need of a key (a physical key, an immobilizer, or the like) for starting the device 16 can be eliminated, and the configuration of the device 16 can be thus simplified.

The management unit 40 includes at least one of the charger that charges the battery 14 or the exchanger that exchanges the battery 14. As described above, by providing the charger or the exchanger with the function of the management unit 40 that stores and erases the device identification information (device ID), the management system 10 does not need a structure for storing and erasing the device identification information into and from the battery 14, and can simplify the configuration of the battery 14.

The charger or the exchanger includes the input unit (reader 44) to which the user identification information (user ID) is input by the user U. When the battery 14 is rented to the user U, the charger or the exchanger causes the device identification information (device ID) to be stored in the battery-side storage unit 80, based on acquisition of the user identification information from the input unit. When the user U returns the battery 14, the charger or the exchanger causes the device identification information to be erased from the battery-side storage unit 80, based on acquisition of the user identification information from the input unit. As a result, the charger or the exchanger can easily perform the storing and the erasing selectively, that is, storing the device identification information when the battery 14 is rented to the user U and erasing the device identification information when the battery 14 is returned by the user U.

The charger or the exchanger is configured to switch between a removal state in which the battery 14 is allowed to be removed and an unremovable state in which the battery 14 is not allowed to be remove. The battery that does not store the device identification information (device ID) is placed into the unremovable state, and when the battery 14 is rented to the user U, the battery 14 that has stored the device identification information is transitioned from the unremovable state to the removable state. Accordingly, the user U can take out the battery 14 in which the device identification information is reliably stored, from the charger or the exchanger.

The management unit 40 includes the management server 28 configured to perform information communication with the charger or the exchanger, the management server including the database configured to store the user identification information (user ID) of the user U who has made a contract for use of the battery 14 and the device identification information (device ID) in association with each other. The management server 28 retrieves the device identification information from the database, based on the user identification information acquired from the charger or the exchanger, and transmits the retrieved device identification information to the charger or the exchanger. As described above, the management system 10 can store the device identification information in the battery 14 by transmitting the device identification information from the management server 28 to the charger or the exchanger even if the charger or the exchanger does not hold the device identification information.

In addition, the management unit 40 includes the user authentication unit 64 configured to authenticate whether or not the user U is authorized to use the battery 14, based on the user identification information (user ID) that has been acquired. As described above, by including the user authentication unit 64, the management system 10 can prevent a person who is not authorized to use the battery 14 from taking out the battery 14.

When the batteries 14 are rented to the user U, the management unit 40 manages the number of batteries 14 to be rented to the user and the user identification information (user ID) in association with each other. In a case that the number of batteries 14 that the user U intends to take out is equal to or less than the number of batteries to be rented to the user, the management unit 40 allows the user U to take out the batteries 14. In a case that the number of batteries 14 that the user U intends to take out is more than the number of batteries to be rented to the user, the management unit 40 restricts the user U from taking out the batteries 14. Accordingly, the management system 10 can limit the number of batteries 14 that the user U takes out, and can avoid a situation in which other persons cannot rent the batteries 14.

The battery-side storage unit 80 can store a plurality of pieces of the device identification information (device IDs). As a result, the management system 10 can use the battery 14 with respect to a plurality of devices 16 possessed by the user U, and the battery 14 is not allowed to be used with respect to devices 16 other than the plurality of devices 16, whereby theft of the battery 14 is prevented.

When the management unit 40 acquires the user identification information (user ID) from the user U, the management unit causes the plurality of pieces of device identification information (device IDs) to be collectively stored in the battery-side storage unit 80 or to be collectively erased from the battery-side storage unit 80. Thus, the management system 10 can easily store or erase a plurality of pieces of device identification information into or from the battery 14.

A second aspect of the present invention is the battery 14 detachably mounted on the device 16 and configured to supply power to the device 16, the battery 14 including: the battery-side storage unit 80 configured to store device identification information (device ID) unique to the device 16; and the control unit 56 configured to perform power supply by the battery 14 in a case where it is determined that at-use authentication identification information (at-use authentication ID) held by the device 16 matches the device identification information, in a state of the battery being attached to the device 16, and configured to stop power supply by the battery 14 in a case where it is determined that the at-use authentication identification information does not match the device identification information, in the state of the battery being attached to the device. The device identification information is stored in the battery-side storage unit 80 or erased from the battery-side storage unit 80, by the management unit 40 that has acquired user identification information (user ID) for identifying the user U who owns the battery 14. Thus, the battery 14 can further improve convenience while preventing theft of the battery 14.

1. A management system that manages a battery detachably mounted on a device, the battery being configured to supply power to the device,
wherein the battery includes:
a battery-side storage unit configured to store device identification information unique to the device; and
a control unit configured to perform power supply by the battery in a case where it is determined that at-use authentication identification information held by the device matches the device identification information, in a state of the battery being attached to the device, and configured to stop power supply by the battery in a case where it is determined that the at-use authentication identification information does not match the device identification information, in the state of the battery being attached to the device,
the management system comprising a management unit configured to cause the device identification information to be stored in the battery-side storage unit or cause the device identification information to be erased from the battery-side storage unit, in a case where user identification information for identifying a user who owns the battery is acquired.

2. The management system according to claim 1, wherein
the management unit includes at least one of a charger configured to charge the battery or an exchanger configured to exchange the battery.

3. The management system according to claim 2, wherein
the charger or the exchanger includes an input unit to which the user identification information is input by the user,
wherein, when the battery is rented to the user, the charger or the exchanger causes the device identification information to be stored in the battery-side storage unit, based on acquisition of the user identification information from the input unit, and
wherein, when the user returns the battery, the charger or the exchanger causes the device identification information to be erased from the battery-side storage unit, based on acquisition of the user identification information from the input unit.

4. The management system according to claim 3, wherein
the charger or the exchanger is configured to switch between a removal state in which the battery is allowed to be removed and an unremovable state in which the battery is not allowed to be removed, and
the battery that does not store the device identification information is placed into the unremovable state, and when the battery is rented to the user, the battery that has stored the device identification information is transitioned from the unremovable state to the removable state.

5. The management system according to claim 2, wherein
the management unit includes a management server configured to perform information communication with the charger or the exchanger, the management server including a database configured to store the user identification information of the user who has made a contract for use of the battery and the device identification information in association with each other, and
the management server retrieves the device identification information from the database, based on the user identification information acquired from the charger or the exchanger, and transmits the device identification information that has been retrieved, to the charger or the exchanger.

6. The management system according to claim 1, wherein
the management unit includes a user authentication unit configured to authenticate whether or not the user is authorized to use the battery, based on the user identification information that has been acquired.

7. The management system according to claim 1, wherein
the battery comprises one or more batteries, and when the batteries are rented to the user, the management unit manages a number of batteries to be rented to the user and the user identification information in association with each other,
in a case that a number of batteries that the user intends to take out is equal to or less than the number of batteries to be rented to the user, the management unit allows the user to take out the batteries, and
in a case that the number of batteries that the user intends to take out is more than the number of batteries to be rented to the user, the management unit restricts the user from taking out the batteries.

8. The management system according to claim 1, wherein
the battery-side storage unit is configured to store a plurality of pieces of the device identification information.

9. The management system according to claim 8, wherein
when the management unit acquires the user identification information from the user, the management unit causes the plurality of pieces of the device identification information to be collectively stored in the battery-side storage unit or to be collectively erased from the battery-side storage unit.

10. A battery detachably mounted on a device and configured to supply power to the device, the battery comprising:
a battery-side storage unit configured to store device identification information unique to the device; and
a control unit configured to perform power supply by the battery in a case where it is determined that at-use authentication identification information held by the device matches the device identification information, in a state of the battery being attached to the device, and configured to stop power supply by the battery in a case where it is determined that the at-use authentication identification information does not match the device identification information, in the state of the battery being attached to the device,
wherein the device identification information is stored in the battery-side storage unit or erased from the battery-side storage unit, by a management unit that has acquired user identification information for identifying a user who owns the battery.

11. The battery according to claim 10,
wherein, when the battery is rented to the user, the device identification information is stored in the battery-side storage unit, based on acquisition of the user identification information by the management unit, and
wherein, when the user returns the battery, the device identification information is erased from the battery-side storage unit, based on acquisition of the user identification information by the management unit.

12. The battery according to claim 10, wherein the battery-side storage unit is configured to store a plurality of pieces of the device identification information.

13. The battery according to claim 12, wherein
when the management unit acquires the user identification information, the plurality of pieces of the device identification information are collectively stored in the battery-side storage unit or collectively erased from the battery-side storage unit.
